(19) United States
(12) Patent Application Publication
(10) Pub. No.: US 2014/0063024 A1
(43) Pub. Date: Mar. 6, 2014

(54) THREE-DIMENSIONAL RANGE DATA COMPRESSION USING COMPUTER GRAPHICS RENDERING PIPELINE

(71) Applicant: IOWA STATE UNIVERSITY RESEARCH FOUNDATION, INC., Ames, IA (US)

(72) Inventors: Song Zhang, Ames, IA (US); Nikolaus Karpinsky, Ames, IA (US); Yajun Wang, Ames, IA (US)

(73) Assignee: IOWA STATE UNIVERSITY RESEARCH FOUNDATION, INC., Ames, IA (US)

(21) Appl. No.: 13/786,639

(22) Filed: Mar. 6, 2013

Related U.S. Application Data
(60) Provisional application No. 61/739,362, filed on Dec. 19, 2012.

(51) Int. Cl. G06T 9/00

(52) U.S. Cl. CPC G06T 9/007
USPC 345/506

(57) ABSTRACT

A method includes obtaining three-dimensional range data, using a computer graphics rendering pipeline to encode the three-dimensional range data into two-dimensional images, retrieving depth information for each sampled pixel in the two-dimensional images, and encoding the depth information into red, green and blue color channels of the two-dimensional images. The two-dimensional images may be compressed using two-dimensional techniques including dithering. The step of obtaining the three-dimensional range data may be performed using a three-dimensional range scanning device. The method may further include storing the two-dimensional images on a computer readable storage medium. The method may further include setting up the viewing angle for the three-dimensional range data. The viewing angle for the three-dimensional range data is a viewing angle of a camera used in obtaining the three-dimensional range data. The computer graphics rendering pipeline may provide for geometry processing, projection, and rasterization.

### CROSS-REFERENCE TO RELATED APPLICATIONS

This application claims priority under 35 U.S.C. §119 to provisional application Ser, No. 61/739,362 filed Dec. 19, 2012, herein incorporated by reference in its entirety.

### FIELD OF THE INVENTION

The present invention relates to computer graphics. More particularly, the present invention relates to naturally encoding three-dimensional (3D) range data into regular two-dimensional (2D) images using a computer graphics rendering pipeline.

### BACKGROUND OF THE INVENTION

With the rapid development of 3D range scanning, especially 3D video scanning techniques, it is becoming increasingly easier to obtain and access 3D content. However, the size of 3D range data is drastically larger than that of its 2D counterparts. Therefore, storing and transporting 3D range data has become an important issue to be dealt with [1].

Conventional formats (e.g., STL, OBJ, PLY) to store 3D range data are effective in terms of 3D surface representation. However, they usually store (x, y, z) coordinates for each vertex, the connectivity information between vertices, and sometimes the surface normal information, and thus utilize a lot of storage space. Over the years, various methods [2-4] have been developed to compress 3D range scanned data. There are generic to arbitrary 3D mesh data, and their compression ratios are quite high. However, these often involve very time-consuming encoding processes, and thus cannot be used for real-time 3D video applications.

Another method is to represent 3D range video data as a phase depth map [5], which has been successfully demonstrated for live 3D video communication. Furthermore, the floating-point phase map could be represented with a regular 24-bit image by packing the most significant 24 bits into red, green, and blue (RGB) channels of the regular image, and discarding the least significant bits. The 24-bit RGB images can then be unpacked to recover 3D geometry with a little quality loss. Though successful, this technique is limited to utilizing lossless 2D image formats. This is because the most significant bits contain the power bits and any change will result in significant error for the unpacked floating point number.

Another approach inspired by research on 3D shape measurement with fringe projection techniques is a 3D range data compression technique using Holoimage [6] to convert 3D data into regular 2D images [7], and later extended to 3D range video compression [1]. Specifically, this technique consists of building a virtual fringe projection system called Holoimaging using advanced computer graphics tools to image virtual 3D objects as 2D RGB images, and to further compress 2D images with standard 2D compression techniques (e.g., JPG, PNG). Since 3D geometry information is encoded into cosine functions, the compression ratio was found to be very high and the recovered 3D geometry was of great quality. However, because one 8-bit channel spatially encodes 2n phase jumps, the Holoimage technique is limited to use a finite number of fringe stripes, resulting in relatively low resolution 2D images to represent 3D geometries, which is problematic if the original 3D range data is of higher resolution.

Thus, although various methods are known for representing 3D range data, what is needed is an improved method for storing and transporting such data.

### SUMMARY OF THE INVENTION

Therefore, it is a primary object, feature, or advantage of the present invention to improve over the state of the art.

It is a further object, feature, or advantage of the present invention to represent 3D range data using two-dimensional images.

It is a further object, feature, or advantage of the present invention to represent 3D range data in a manner that allows for compression with high compression ratios to facilitate storage and transport.

It is a still further object, feature, or advantage of the present invention to facilitate use of 3D range data of high resolution.

Another object, feature, or advantage of the present invention is to represent 3D range data with 3 bits allowing for reduced data size.

Yet another object, feature, or advantage of the present invention is to provide for storing both 3D data and 2D texture images in an 8-bit grayscale image.

These and/or other objects, features, or advantages of the present invention will become apparent from the specification and claims that follow. No single embodiment need meet each and every object, feature, or advantage as it is contemplated that different embodiments may have different objects, features, or advantages.

The present invention provides for naturally encoding three-dimensional (3D) range data into regular two-dimensional (2D) images utilizing a computer graphics rendering pipeline. The computer graphics pipeline provides a means to sample 3D geometry data into regular 2D images, and also to retrieve the depth information for each sampled pixel. The depth information for each pixel is further encoded into red, green and blue (RGB) color channels of regular 2D images. The 2D images can further be compressed with existing 2D image compression techniques. By this novel means, 3D geometry data obtained by 3D range scanners can be instantaneously compressed into 2D images, providing a novel way of storing 3D range data into its 2D counterparts. Experimental results verify the performance of this proposed technique.

According to one aspect, a method includes obtaining three-dimensional range data, using a computer graphics rendering pipeline to encode the three-dimensional range data into two-dimensional images, retrieving depth information for each sampled pixel in the two-dimensional images, and encoding the depth information into red, green and blue color channels of the two-dimensional images. The two-dimensional images may be compressed. The step of obtaining the three-dimensional range data may be performed using a three-dimensional range scanning device. The method may further include storing the two-dimensional images on a computer readable storage medium. The method may further include setting up the viewing angle for the three-dimensional range data. The viewing angle for the three-dimensional range data is a viewing angle of a camera used in obtaining the three-dimensional range data. The computer graphics rendering pipeline may provide for geometry processing, projection, and rasterization. The method may further include recovering three-dimensional range data from the two-dimensional images and displaying a representation of the three-dimensional range data.

According to another aspect, a representation of three-dimensional range data stored on a computer readable storage medium includes a plurality of two-dimensional images stored in a two-dimensional image file format wherein the two-dimensional images encode the three-dimensional range data with depth information for the three-dimensional range data encoded into red, green, and blue color channels of the two-dimensional images.

According to another aspect, a method includes providing a plurality of two-dimensional images stored in a two-dimensional image file format wherein the two-dimensional images encode the three-dimensional range data with depth information for the three-dimensional range data encoded into red, green, and blue color channels of the two-dimensional images. The method further includes recovering the three-dimensional range data from the two-dimensional images. The method may further include displaying a representation of the three-dimensional range data.

### BRIEF DESCRIPTION OF THE DRAWINGS

FIG. 1 illustrates one example of a computer graphics rendering pipeline.

FIGS. 2A-2L illustrate experimental results of an ideal sphere. FIG. 2A show an encoded 2D color image; FIGS. 2B-2D show three color channels; FIG. 2E shows wrapped phase from red and green channels; FIG. 2F shows a stair image; FIG. 2G shows an unwrapped phase; FIG. 2H shows 3D recovered results; FIGS. 2I-2L show 3D results from JPG images with quality levels of 12, 10, 8, and 6, respectively.

FIGS. 3A-3J provide a comparison between the ideal sphere and the recovered 3D results from different quality 2D images. FIGS. 3A-3E show cross sections of the ideal shape and the recovered 3D results shown in FIGS. 2H-2L; FIGS. 3F-3J show errors for the cross sections shown above. The rms errors for FIGS. 3F, 3G, 3H, 3I, and 3J are 0.006%, 0.022%, 0.033%, 0.052%, and 0.051%, respectively.

FIGS. 4A-4H provide experimental results of more complex 3D statue. FIG. 4 shows original 3D data; FIG. 4B shows an encoded 2D image for the 3D data; FIG. 4C shows a recovered 3D shape from the lossless PNG image; FIG. 4D shows overlapping between original and recovered 3D data; FIGS. 4E-4H show 3D results from lossy JPG images with quality levels 12, 10, 8, and 6, respectively.

FIGS. 5A-H illustrate multi-resolution experiments. FIGS. 5A-5D are four images with each representing ¼ of the 1k×1k full-resolution image; FIG. 5E illustrates a combined full-resolution image; FIG. 5F illustrates a recovered 3D result from the high-resolution image shown in FIG. 5E; FIG. 5G is a low-resolution image (256×256); FIG. 5H illustrates a recovered 3D shape from the low-resolution image shown in FIG. 5G.

FIG. 6 illustrates a holovideo system conceptual model. The virtual projection system projects sinusoidal fringe patterns onto the object, the result is rendered by the graphics pipeline, and then displayed on the screen. The screen view acts as a virtual camera imaging system. Because both the projector and the camera are virtually constructed, they can both be orthogonal devices. The angle between the projection system and the camera imaging system is θ.

FIGS. 7A-7F illustrate results of dithering on a unit sphere in a loseless image format. FIG. 7A is an original Holoimage; FIG. 7B is a Holoimage with Bayer dithering;

FIG. 7C is a Holoimage with Floyd-Steinberg dithering; FIG. 7D is a 3D constructed results for image shown in FIG. 7A; FIG. 7E provides 3D reconstructed results for image shown in FIG. 7B; FIG. 7F provides 3D reconstructed results for image shown in FIG. 7C.

FIG. 8A-8F illustrate reconstruction errors of dithering on unit sphere in a lossless image format. FIG. 8A illustrates a cross section of reconstructed result show in FIG. 7D; FIG. 8B illustrates a cross section of reconstructed result show in FIG. 7E; FIG. 8C illustrates a cross section of reconstructed result show in FIG. 7F; FIG. 8D illustrates reconstruction error between the reconstructed and ideal unit sphere for the result in FIG. 8A; FIG. 8F illustrates reconstruction error between the reconstructed and ideal unit sphere for the result in FIG. 8B (rms error 0.33%); FIG. 8F illustrates reconstruction error between the reconstructed and ideal unit sphere for the result in FIG. 8C (rms error 0.2%).

FIGS. 9A-9B illustrate different ways to hold a packed dithered Holoimage. FIG. 9A illustrates dithered channels packed in three most significant bits and saved as grayscale PNG with resulting file size of 79 KB; FIG. 9B illustrates dithered channels packed into a planar format and then saved as a logical PNG with resulting filesize of 62 KB.

FIGS. 10A-10F illustrate results of a dithering on scan of a David statue in a lossless image format. FIG. 10A provides an original Holoimage; FIG. 10B illustrates a Holoimage with Bayer dithering; FIG. 10C illustrates a Holoimage with Floyd-Steinberg dithering; FIG. 10D illustrates a recovered 3D geometry from FIG. 10A; FIG. 10E illustrates recovered 3D geometry from FIG. 10B (rms error 0.37%); FIG. 10F illustrates recovered 3D geometry from FIG. 10C (rms error 0.34%).

FIGS. 11A-11D illustrate packing dithered Holoimage with texture. FIG. 11A illustrates a 3-bit packed Holoimage with 8-bit grayscale texture; FIG. 11B illustrates 3D geometry with original 8-bit texture mapping; FIG. 11C illustrates 3-bit packed Holoimage with 1-bit dithered texture; FIG. 11D Rendered 3D geometry with 1-bit dithered texture mapping.

### DETAILED DESCRIPTION OF THE PREFERRED EMBODIMENTS

Various embodiments are described herein. Part A is directed generally towards three-dimensional range data compression using a computer graphics rendering pipeline. Part B is generally directed towards three bit representation of three-dimensional range data.

The various embodiments may take the form of hardware embodiments, software embodiments, or embodiments combining software and hardware. Where software is used, computer-useable instructions may be embodied on one or more computer-readable storage media. Computer-readable storage media may include volatile and/or nonvolatile media. Various embodiments may use one or more computing devices, and a computing device is understood to include a general purpose computer, a specific purpose computer of any number of types including that which may be associated with a camera, a phone, or other types of hardware.

A. Three-Dimensional Range Data Compression using Computer Graphics Rendering Pipeline

1. Introduction

One aspect of the present invention provides a method to overcome the limitations of the Holoimage compression method by eliminating its spatial encoding requirement. Instead, this method directly encodes depth (z information) into RGB images. This method naturally encodes 3D range data into regular 2D images utilizing an advanced computer graphics pipeline (e.g., OpenGL). To render 3D geometry into 2D images on a computer screen, the computer graphics rendering pipeline provides a means to sample 3D geometry data into 2D images. Moreover, the advanced computer graphics tools also provide a way to obtain the depth (z) for each sampled pixel. The depth information for each pixel is further encoded into RGB color channels of a regular 2D image. The 2D images can then be compressed with existing 2D image compression techniques. Similar to the Holoimage method, each channel of the RGB image is represented as a cosine function, and thus the encoded 2D image can be highly compressed without a significant loss of quality. Comparing with our Holoimage compression technique, this technique directly encodes depth z into 2D images without spatial encoding, and thus it can be extended to sample arbitrary size 3D objects into arbitrary resolution 2D images. Moreover, because 3D objects can be rendered onto computer screen at a high speed, this novel encoding technique permits compressing 3D data into 2D images in real time, providing an effective and efficient means to store 3D range data into their 2D components.

Section 2 explains the principle of encoding and decoding. Section 3 shows experimental results. Section 4 discusses the merits and limitations of the proposed technique, and Section 5 summarizes.

2. Principle

2A. Phase-Shifting Technique for 3D Shape Measurement

Phase-shifting techniques have been extensively adopted in optical metrology due to its numerous merits over other techniques, such as their capability to achieve pixel-by-pixel spatial resolution. Over the years, numerous phase-shifting algorithms have been developed, as summarized in this book chapter [8]. Although a multiple-step phase-shifting algorithm is not very sensitive to linear phase shift errors [9], a three-step phase-shifting algorithm is usually desirable for high-speed applications since it requires the minimum number of fringe images to obtain high-quality phase. For a three-step phase-shifting algorithm with equal phase shifts, three fringe images can be described as,

I₁(x, y)=I′(x, y)+I″(x, y) cos(φ−2π/3), (1)

I₂(x, y)=I′(x, y)+I″(x, y) cos(φ), (2)

I₃(x, y)=I′(x, y)+I″(x, y) cos(φ+2π/3). (3)

Where I′(x, y) is the average intensity, I″(x, y) the intensity modulation, and φ(x, y) the phase to be found. From these three equations, we can calculate the phase,

$$φ ( x , y ) = {tan}^{- 1} [ \frac{\sqrt{3} ( {I}_{1} - {I}_{3} )}{2 {I}_{2} - {I}_{1} - {I}_{3}} ] \qquad ( 4 )$$

This equation provides the wrapped phase ranging from 0 to 2π with 2π discontinuities. Conventionally, these 2π phase jumps can be removed by adopting a spatial phase-unwrapping algorithm, such as one of the algorithms discussed in Book [10]. If the system is properly calibrated [11], (X, Y, Z) coordinates can be obtained from the unwrapped phase φ(x, y) pixel by pixel,

X=f₁(x, y, Φ), (5)

Y=f₂(x, y, Φ), (6)

Z=f₃(x, y, Φ) (7)

However, since a spatial phase unwrapping algorithm is adopted, such a system can neither measure large step-height changes that cause phase changes larger than π, nor does it handle discontinuous surfaces.

2.B. Holoimage Encoding

It is important to notice that the X and Yin Eqs. (5) and (6) are usually not uniformly distributed for 3D range data coming from a 3D shape measurement system, and thus it is not sufficient to solely use depth Z to represent recovered 3D shapes. On the other hand, to compress 3D range data, it is desirable to ensure that X and Y are uniformly distributed.

To accomplish this task, we have previously developed a virtual fringe projection system called Holoimage [6]. In such a system, both the projector and the camera use “telecentric lenses” so that they create parallel projections instead of perspective projection, making the spatial sampling uniform, in other words, X and Y are uniformly distributed.

Since the Holoimage system is virtually built, the “ambient light” can be controlled, and the surface reflectivity can be perfectly uniform. Therefore, only two fringe images are required to recover the phase, making it possible to use the third image to assist phase unwrapping. Modifying from Eqs. (1)-(3), three encoded patterns can be described as

I_{y}(x, y)=127.5+127.5 sin(2πx/P), (8)

I_{y}(x, y)=127.5+127.5 cos(2πx/P) (9)

I_{b}(x, y)=S·Fl(x/P)+0.5+0.5(S−2)·cos[2π·Mod(x, P)/P₁]. (10)

Here P is the fringe pitch, the number of pixels per fringe stripe, P₁=P/(K+0:5) is the local fringe pitch and K is an integer number, S is the stair height in grayscale value, Mod(a, b) is the modulus operator to get a over b, and Fl(x) is to get the integer number of x by removing the decimals. It should be noted that Eq. (10) varies sinusoidally to enable lossy compression [1]. Both the aforementioned method and the previously proposed technique [7] utilized a stair image to ensure that the stair changes perfectly align with the 2π discontinuities.

From these three images and the setup parameters of the Holoimaging system, (X, Y, Z) coordinates can be recovered as

$$\begin{matrix}{X}^{n} = j \text{/} W , & ( 11 ) \\ {Y}^{n} = i \text{/} W , & ( 12 ) \\ {Z}^{n} = \frac{P Φ ( x , y ) - 2 π i cos ( θ )}{2 π W sin θ} . \\ Where & ( 13 ) \\ Φ ( x , y ) = 2 π \times Fl [ ( {I}_{b} - 0.5 S ) \text{/} S ] + {tan}^{- 1} [ \frac{{I}_{T} - 127.5}{{I}_{g} - 127.5} ] . & ( 14 )\end{matrix}$$

θ is the angle between the projector and the camera, (I, j) are image pixel indices, W is the image width, and (Xⁿ, Yⁿ, Zⁿ) are normalized coordinates that can be converted back to their original coordinates by applying the predefined scaling factor and translation vector. It is important to note that in this case, the Holoimaging system was set up so that both the projector and the camera use orthographic projections, and the fringe stripes are vertical along y direction (i.e., vary horizontally along x direction).

2. C. Direct Depth Z Encoding

However, because of quantization error, the stair height cannot be only 1 gray scale value. Furthermore, lossy compression techniques require much larger stair height to ensure that coded images are less vulnerable to noise. In practice, the stair height is usually larger than 10. This means that there are only approximately 25 stairs to use. Since the fringe patterns are spatially (along x or y direction) sampled by the virtual fringe projection system, the Holoimage technique can neither encode dense fringe images nor reach high-resolution representation.

In contrast, if the encoding is performed along depth Z direction, instead of spatially along X or Y, the spatial resolution limitation will be eliminated. In other words, we directly encode depth Z such that

$$\begin{matrix} {I}_{r} ( i , j ) = 127.5 + 127.5 sin ( 2 π Z \text{/} P ) , & ( 15 ) \\ {I}_{g} ( i , j ) = 127.5 + 127.5 cos ( 2 π Z \text{/} P ) , & ( 16 ) \\ {I}_{b} ( i , j ) = S \times Fl ( Z \text{/} P ) + 0.5 S + 0.5 ( S - 2 ) \times cos [ 2 π \times \frac{Mod ( Z , P )}{{P}_{1}} ] , & ( 17 )\end{matrix}$$

Equations (15)-(17) provide the depth Z uniquely for each point:

$$Z = P [ Fl ( \frac{{I}_{b} - 0.5 S}{S} ) + \frac{1}{2 π} \times {tan}^{- 1} ( \frac{{I}_{T} - 127.5}{{I}_{g} - 127.5} ) ] . \qquad ( 18 )$$

If the X and Y coordinates are sampled uniformly so that they are proportional to their image indices (I, j), which are scaled by the pixel size, i.e.,

X=j x c, (19)

Y=I x c. (20)

Here c is constant that can be specified by the user. By this means, 3D shape can also be encoded as a single image while eliminating some limitations of the Holoimage system.

2.D. Computer Graphics Rendering Pipeline (CGRP) for Uniform Sampling

The depth Z encoding technique introduced in Subsec. 2.0 requires directly sampling 3D range data uniformly along X and Y directions. Unfortunately, this is usually non-trivial considering the irregular shape of the object, and the irregular (x, y) coordinates coming from a range scanner. Utilizing a conventional interpolation technique could be extremely time-consuming. The present invention addresses this challenge by taking advantage of the computer graphics rendering pipeline (CGRP).

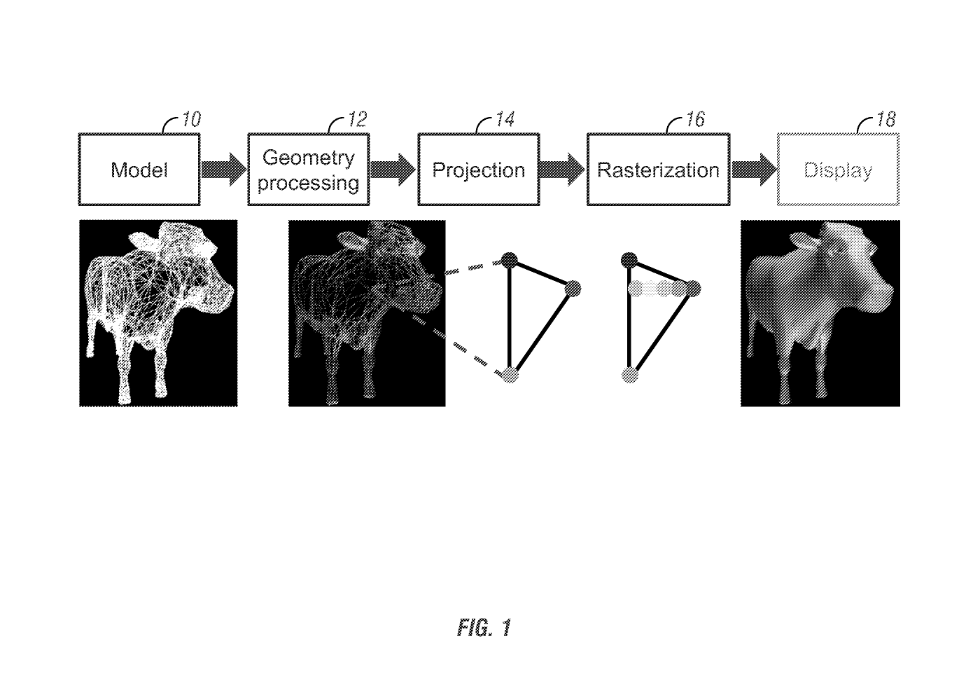

FIG. 1 illustrates the typical rendering pipeline that starts with geometry processing 12 after a model 10 is provided. The geometry processing step takes care of back-face culling that removes vertices that face away from the viewer; in the projection step 14 the frontal vertices are then projected 3D coordinates onto a 2D image plane by applying the projection matrix; the rasterization stage 16 fills in the polygons (if required) through 2D interpolation, and removes those points that are hidden by another through depth buffering; finally, the 2D images are displayed on 2D computer screen or other display 18 pixel by pixel.

Since most computer screens contain squared pixels, this computer graphics rendering pipeline usually results in squared 2D points on the computer screen. If the projection is orthographical, then the screen coordinates (I, j) are naturally proportional to the original (X, Y) coordinates in the object space. This means that the CGRP provides a means to sample 3D shape uniformly along x and y directions. Since the advanced computer graphics tools can do high-resolution, real-time 3D rendering, it thus also provides a very efficient way for this procedure. Therefore, if we can obtain depth Z pixel by pixel on the computer screen, we can adopt the direct depth encoding technique introduced in Subsec. 2.0 for 3D compression. Fortunately, the advanced computer graphics rending techniques provide a way called render to texture. By rendering the scene to texture instead of computer screen, the depth Z can be recovered pixel by pixel through unprojection. The present invention uses this methodology for 3D range data encoding, and thus for 3D shape compression.

3. Experiments

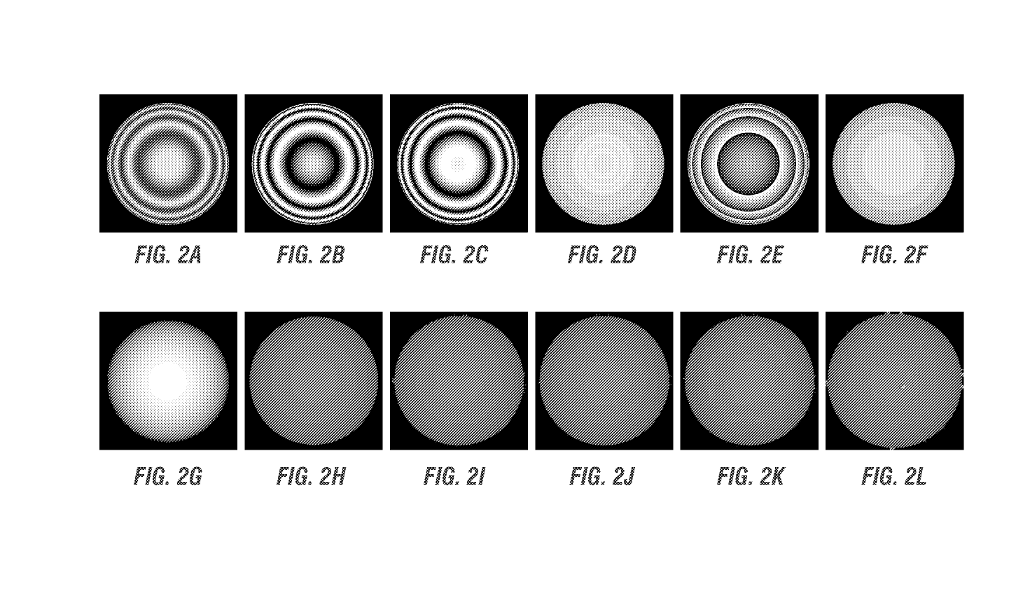

We experimented with an ideal unit sphere generated by a computer to verify the performance of the proposed technique. In this experiment, the 3D sphere was rendered to a 512×512 resolution texture. For each pixel, the depth information was recorded and encoded into color information following Eqs. (15)-(17). The 2D encoded image is shown in FIG. 2A, and FIGS. 2B-2D show its three color channels. From red and green channels, the wrapped phase can be obtained, as shown in FIG. 2E. FIG. 2F shows the stair image that can be quantified into k(x, y) for phase unwrapping. The unwrapped phase map is shown in FIG. 2G. It is important to note that due to sampling and/or noise for lossy image formats, the perfectly aligned phase jumps and the stair changes may shift 1 or 2 pixels. To solve this problem, the unwrapped phase was processed by a 13×13 median filter to locate those misaligned pixels, and then properly adjust the k(x; y) for those pixels. After this step, the depth map can be properly obtained.

Since the pixel size is precisely defined for this pipeline, the 3D shape can be recovered, as shown in FIG. 2H. Furthermore, we stored the 2D image in lossy image formats, such as the JPG format with different qualities, and recovered the 3D shapes from those lossy image formats. FIGS. 2I-2L show the results when the images were stored at quality levels of 12, 10, 8, and 6, respectively. The quality level was defined by Adobe Photoshop CS3 with 12 being the best quality JPG format. This experiment shows that if the encoded 2D image is stored as a lower quality JPG file (with more compression), the recovered 3D sphere from the lower quality JPG file is lower. Also, one may notice that the sphere is no longer smooth for those 3D results recovered from lower quality 2D JPG files, and some artifacts appears on the sphere. Nevertheless, all 3D shapes are properly recovered even if the image quality is as low as level 6 (the size is approximately 57 KB for a 512×512 image).

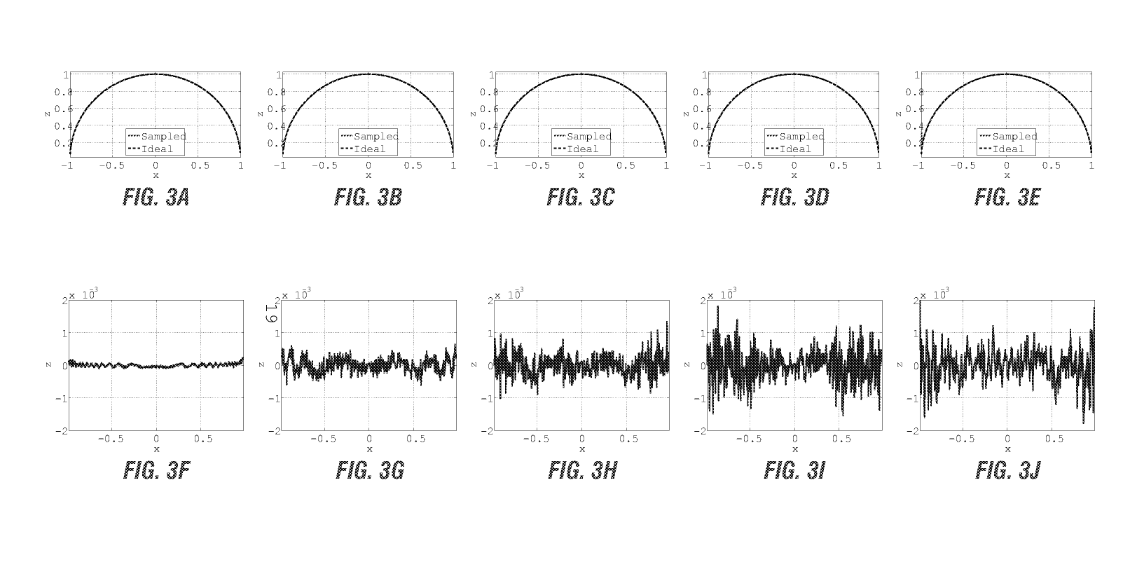

To verify the accuracy of the recovered 3D sphere comparing with the ideal one, cross sections of the recovered 3D data from the results shown in FIG. 2H were presented in FIGS. 3A-3J. FIG. 3A shows the cross section of overlaying the recovered 3D shape shown in FIG. 2H with the ideal one. It can be seen that they are almost identical. FIG. 3F shows the difference between these two cross sections. The 3D shape is recovered from virtually encoding the depth into color images, but this figure shows some noise. The random noise was introduced during the quantization process when the floating point data was converted to 8-bit fringe images. The error was found to be approximately root-mean-square (rms) value of 0.006%. This indeed shows that the encoding technique can represent the original geometry with high accuracy if they are stored in a lossless image format, such as PNG. Moreover, the larger error on both ends was caused by the sampling limitation: it is impossible to sample the depth data when the sampling direction is parallel to the surface tangent plane. For this example, the largest angle between the sphere surface normal direction and the sampling direction is approximately 84°. As a comparison, FIGS. 3B-3E and 3G-3J show the results if 3D shapes are recovered from lossy JPG images. It can be seen that the rms error is larger if the 2D JPG image is compressed more. It is important to note that the rms error is still pretty small (less than 0.051%) even if the 2D images are stored as a very low-quality JPG file.

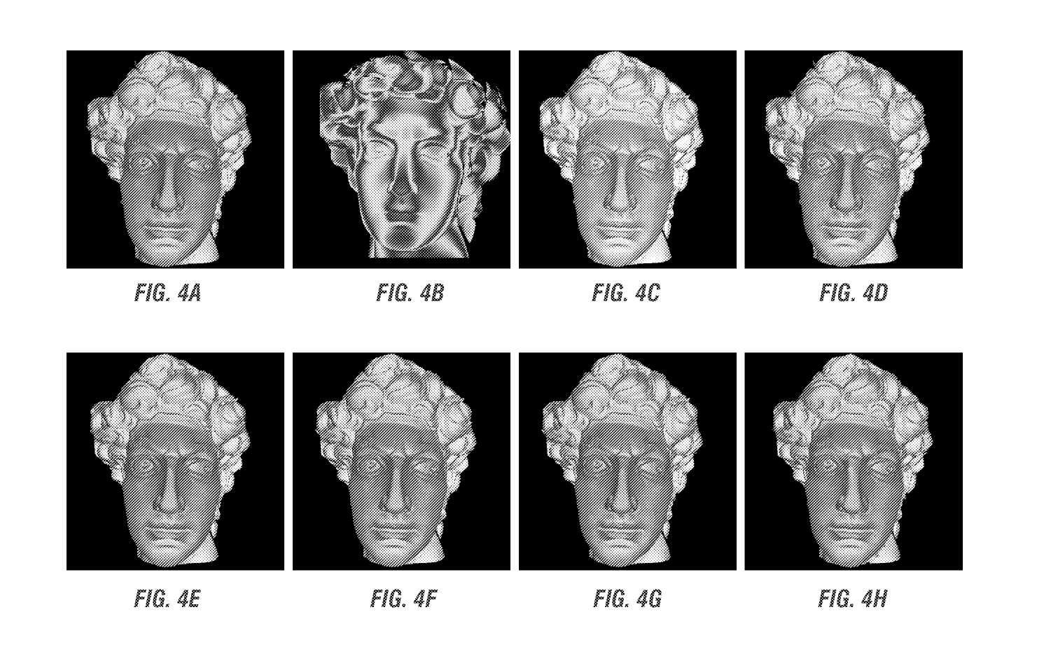

Moreover, a more complex 3D geometric shape was compressed with the proposed technique, as shown in FIG. 4A-4H. FIG. 4A shows the original 3D statue, and FIG. 4B shows the encoded 2D image, from which the 3D shape can be recovered, as shown in FIG. 4C, when the image is stored as the lossless PNG format. Overlaying the original 3D data with the recovered one (FIG. 4D) shows no obvious differences between them. This once again verifies that the proposed encoding technique can represent the original 3D data with a high quality. We then stored the 2D image with the lossy JPG format under different quality levels. The recovered 3D results are shown in FIG. 4E-4H. These again showed that even with low quality JPG images, the overall 3D shape can still be properly recovered, even though some details were lost.

As aforementioned, converting 3D data to 2D images can significantly reduce storage size. We use the statue example to illustrate the compression ratios of the encoded image formats in comparison with three popular 3D mesh formats: OBJ, PLY, and STL. OBJ and PLY formats are widely used in computer graphics, whilst the STL format is extensively used in manufacturing industry. Table 1 summarized the data. This table shows that even converting the 3D data to lossless BMP format, the lowest compression ratio is still above 10:1. If the image is stored as the highest quality JPG format, a 53:1 compression ratio is achieved in comparison with the STL format. If the lower quality 3D geometry is sufficient, the compression ratio can go over 360:1 comparing with the OBJ format. This experiment indeed shows that the huge storage space can be saved by storing the 3D geometry into the 2D image with the proposed compression technique.

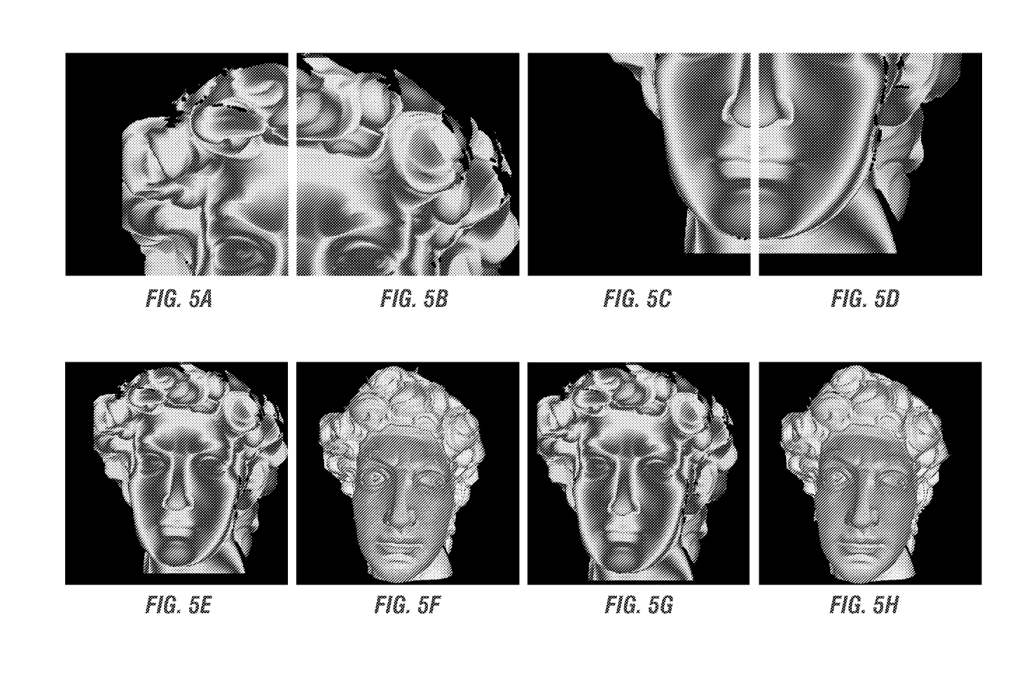

Finally, the multi-resolution representation was tested for this proposed technique. Unlike the previously proposed techniques, this technique can represent any resolution 3D shape properly. This functionality was realized by changing the field view of computer graphics pipeline, precisely moving the view patch by patch, and stitching the resultant images into a complete image. FIGS. 5A-5D show four sub images with each being 512×512. These four sub images were combined into a lk x lk resolution single image as shown in FIG. 5E, from which the 3D shape can be recovered. FIG. 5F shows the recovered 3D shape from the high resolution image. It clearly shows a lot more details than that shown in lower resolution images such as those shown in FIGS. 4E-4H. Furthermore, the low resolution image can be easily generated. For example, FIG. 5G shows the 256_{—}256 resolution encoded image, and FIG. 5H shows the recovered 3D result. It can be seen that the 3D shape lost a lot details, but the overall 3D shape was still properly recovered.

4. Discussions

The proposed compression technique of the present invention has the following merits over the previously proposed Holoimage technique
Multi-resolution capability. This proposed technique allows for representing 3D shapes with 2D images of arbitrary size. Since it directly encodes depth into RGB color channels of the image, the limitation of Holoimage technique does not present in this new technique.
Easy encoding and decoding. This technique directly utilizes the computer graphics rendering pipeline without additional configurations, and thus it could be potentially the most efficient means to instantaneously perform encoding and decoding.
Flexible depth range encoding. This technique normalizes depth z to range of [0, 1] before encoding process, and thus the depth z range could be large or small.

However, the proposed technique is still limited to encode one side of the surface, meaning that the back surface information will be lost. Therefore, setting up the viewing angle becomes vital to encoding the most important data coming from a range scanner. Nevertheless, this technique is especially valuable if it is directly linked with a 3D range scanning device, since the view can be set up to be the same as the real camera's view. By this means, minimum information will be lost, but the storage space can be drastically saved.

5. Summary

The present invention provides for naturally encoding 3D range data into regular 2D images utilizing an advanced computer graphics rendering pipeline. We have demonstrated the viability of the techniques of the present invention. Experimental data showed that this technique does not have the spatial resolution limitation of the previously proposed Holoimage encoding technique. Moreover, this proposed technique has the potential to instantaneously compress and transport 3D live videos captured from 3D range scanning devices.

### B. Three Bit Represention of Three-Dimensional Range Data

1. Introduction

Advancements in real-time 3D scanning are being made at an unprecedented rate, driving the technology further into mainstream life, as can be seen from real-time 3D scanners such as the Microsoft Kinect [12, 13]. With these advancements, large amounts of data are being generated, bringing forth the challenge of streaming and storing this information in an efficient manner. Classical geometry compression approaches compress the 3D geometry and its attributes such as normals, texture coordinates, etcetera, in a model format such as OBJ, PLY, STL. Though these formats work well for static scans or structured meshes, the same does not hold true for 3D scans from a real-time 3D scanner due to its unstructured nature [1].

To address this challenge newer approaches better suited to data coming from 3D scanners have been developed, including heuristic based point cloud encoding [2, 3] and image based encoding approaches [6, 14, 15]. Image based encoding approaches work well as the geometry can be projected into images, then 2D image compression can be utilized until 3D reconstruction is desired. Since 2D image compression is a long studied field, high compression ratios with relatively low amounts of error can achieved.

Holoimage [6] is an image based encoding technique that has been developed, which allows for real-time encoding and decoding at high compression ratios. It leverages techniques from optical metrology, namely fringe projection. Due to the error tolerance in fringe projection, the fringe patterns can be highly compressed with little error to the reconstructed 3D geometry. Karpinsky and Zhang [7] proposed to utilize the Holoimage technique and Hou et al. [16] proposed a similar virtual structured light technique to compress 3D geometry. Based on Holoimage's real-time encoding and decoding, it is able to compress data from real-time 3D scanners [1]. With these merits, it is well suited as a format for high speed 3D scans, which can then be streamed and stored.

Although Holoimage is a good technique for compressing 3D geometry from a real-time 3D scanner, it still uses 24 bits to represent a 3D coordinate, which in practice takes up the three standard image channels (Red, Green, and Blue). With this representation there is no room in a standard image for other information such as a texture or a normal map. This research addresses this by representing the image with only 3 bits instead of 24 through the use of image dithering. This leaves 21 remaining bits for other information such as texture or normal maps, allowing for more information to be stored and streamed. With this new encoding, compression ratios of 8.1 : 1 have been achieved when compared with a 24 bit Holoimage with a mean squared error of .34%.

Section 2 explains the principle behind Holoimage, applying image dithering, and how it fits into the Holoimage pipeline. Section 3 shows experimental results of a 3D unit sphere and David bust and discusses the findings. Finally, Section 4 summarizes section B of this application.

2. Principle

2.A. Holoimage Encoding and Decoding

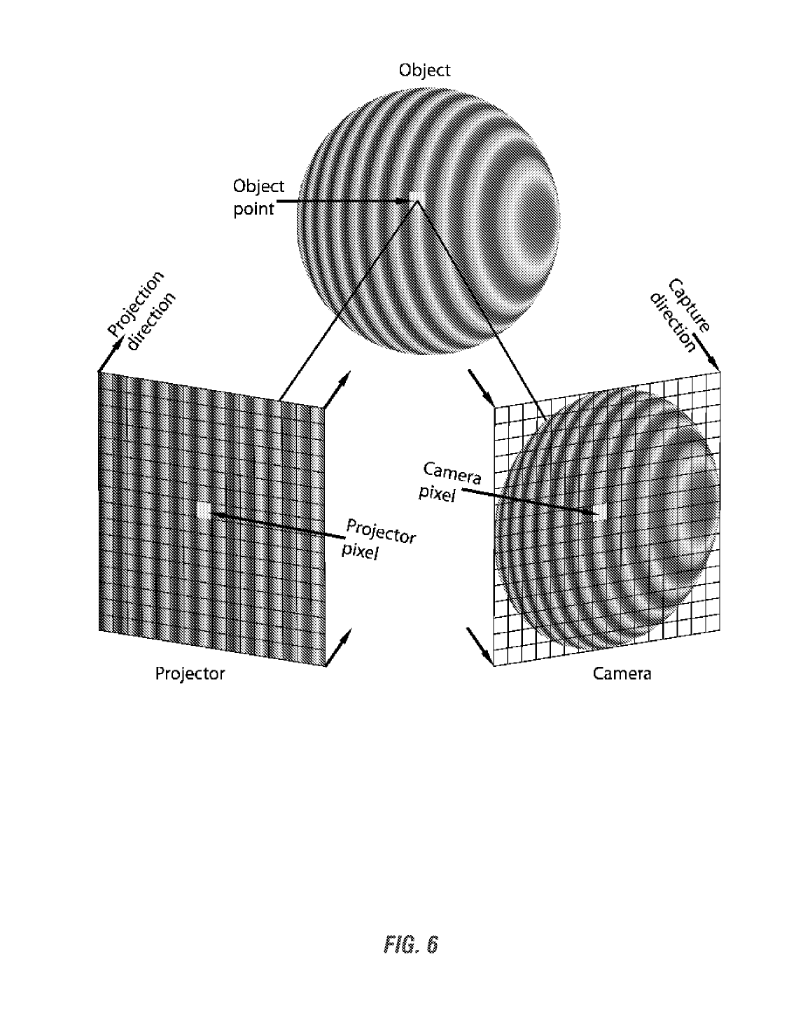

Holoimage is a form a 3D geometry representation that is well suited to quickly and efficiently compressing 3D geometry coming from 3D scanners [7]. It works off of the principle of fringe projection from optical metrology. Encoding works by creating a virtual fringe projection system and virtually scanning 3D geometry into a set of 2D images which can then later be used to decode back into 3D. FIG. 6 shows a conceptual model of the Holovideo system. The projector projects a pattern onto the geometry, which can be done using OpenGL shaders [1], and then the camera captures the resulting scene, which can be done by saving the framebuffer as an image. Once in the image format, standard 2D image processing techniques such as compression or dithering can be applied.

Details of the Holoimaging encoding and decoding algorithms have been thoroughly discussed in Ref. [1], we only briefly explain these algorithms here. The Holoimage encoding colors the scene with the structured light pattern. To accomplish this, the model view matrix of the projector is rotated around the z axis by some angle (e.g., 0=30) from the camera matrix. Each point is colored with the following three equations,

Iᵣ(x, y)=0.5+0.5 sin(2πx/P), (21)

I_{g}(x, y)=0.5+0.5 cos(2πx/P), (22)

I_{b}(x, y)=S·Fl(x/P)+S/2+(S−2)/2·cos[2π·Mod(x, P)/P₁], (23)

Here P is the fringe pitch, the number of pixels per fringe stripe, P₁=P/(K+0.5) is the local fringe pitch and K is an integer number, S is the stair height in grayscale intensity value, Mod(a, b) is the modulus operator to get a over b, and Fl(x) is to get the integer number of x by removing the decimals.

Decoding the resulting Holoimage is more involved than encoding involving four major steps: (1) calculating the phase map from the Holoimage frame, (2) filtering the phase map, (3) calculating normals from the phase map, and (4) performing the final render. A multipass rendering was utilized to accomplish these steps, saving results from the intermediate steps to a texture, which allowed us to access neighboring pixel values in proceeding steps.

Equations (21)-(23) provide the phase uniquely for each point,

Φ(x, y)=2π×Fl[(I_{b}−S/2)/S]tan⁻¹[(I_{y}−0.5)/(Iᵣ−0.5)] (24)

It should be noted the phase is already unwrapped, and thus no spatial phase unwrapping is required for this process. From the unwrapped phase Φ(x, y), the normalized coordinates (xⁿ,yⁿ,zⁿ) can be decoded as [7]

$$\begin{matrix}{x}^{n} = j / W , & ( 25 ) \\ {y}^{n} = i / W , & ( 26 ) \\ {z}^{n} = \frac{P Φ ( x , y ) - 2 πcos ( θ )}{2 π W sin ( θ )} & ( 27 )\end{matrix}$$

This yields a value zⁿ in terms of P which is the fringe pitch, i, the index of the pixel being decoded in the Holoimage frame, θ, the angle between the capture plane and the projection plane (θ=30° for our case), and W, the number of pixels horizontally.

From the normalized coordinates (xⁿ,yⁿ,zⁿ), the original 3D coordinates can recovered point by point

x=xⁿ×Sₑ+Cₓ, (28)

y=yⁿ×Sₑ+C_{y}, (29)

z=zⁿ×Sₑ+C_{z} (30)

Here Sₑ is the scaling factor to normalize the 3D geometry, (Cₓ,C_{y},C_{z}) are the center coordinates of the original 3D geometry.

2.B. Image Dithering

Image dithering is the process of taking a higher color depth image and reducing the color depth to a lower level through a quantization technique [17]. Different types of image dithering techniques exist such as ordered dithering [18] and error diffusing [19]. In this research, two of the most popular algorithms were investigated, Bayer [18] and Floyd-Steinberg [20] dithering.

2.B.1. Bayer Dithering

Bayer dithering, sometimes known as ordered dithering, involves quantizing pixels based on a threshold matrix [18]. In the simple case of quantizing to a binary image, it involves taking each pixel in an image and applying Algorithm 1.

Algorithm 1: Bayer Dithering

```
Input: Pixel -Structure representing properties of a pixel in an image. Has
        color components ranging from 0.0 to 1.0
Input: ThresholdMap -Matrix of threshold values
Output: Pixel.color -Pixel's dithered color component, either 0 or 1
for Each Pixel do
    if Pixel.color >= ThresholdMap[pixel.x mod mapWidth]
    [pixel.y mod mapHeight]
    then
        Pixel.color = 1;
    else
        Pixel.color = 0;
    end
end
```

$$M = \frac{4.0}{255.0} * [ \begin{matrix}0 & 32 & 8 & 40 & 2 & 34 & 10 & 42 \\ 48 & 16 & 56 & 24 & 50 & 18 & 58 & 26 \\ 12 & 44 & 4 & 36 & 14 & 46 & 6 & 38 \\ 60 & 28 & 52 & 20 & 62 & 30 & 54 & 22 \\ 3 & 35 & 11 & 43 & 1 & 33 & 9 & 41 \\ 51 & 19 & 59 & 27 & 49 & 17 & 57 & 25 \\ 15 & 47 & 7 & 39 & 13 & 45 & 5 & 37 \\ 63 & 31 & 55 & 23 & 61 & 29 & 53 & 21\end{matrix} ] \qquad ( 31 )$$

Equation (31) gives an example of an 8×8 threshold matrix, which was also the matrix used in this work. With this algorithm, the threshold map adds minor local error noise to the quantized pixel, but the overall intensity is preserved. Since this algorithm is a parallel algorithm, it can easily be integrated into the Holoimage pipeline in the fragment shading stage of the encoding allowing for little to no overhead in encoding.

2.B.2. Floyd-Steinberg Dithering

Floyd-Steinberg dithering is a form of error diffusing dithering, which diffuses quantization error of a specific pixel into neighboring pixels effectively reducing the overall quantization error [20]. The original Floyd-Steinberg dithering algorithm is given with Algorithm 2.

Algorithm 2: Floyd-Steinberg Dithering

```
Input: Image -Original Image to be dithered. Has color components
    ranging from 0.0 to 1.0
for y ← 0 to Image.Height do
    for x ← 0 to Image.Width do
    if Image.Pixel(x,y).color >= 0.5 then
        newColor = 1;
    else
        newColor = 0;
    end
    quantError = Image.Pixel(x,y) -newColor; Image.Pixel(x,y) =
    newColor;
        //Diffuse Error;
        Image.Pixel(x+1,y) += 7/16 * quantError;
        Image.Pixel(x−1,y+1) += 3/16 * quantError;
        Image.Pixel(x,y+1) += 5/16 * quantError;
        Image.Pixel(x+1,y+1) += 1/16 * quantError;
    end
end
```

In the first part of the algorithm, the images pixel value is quantized into either 1 or 0. Then the quantization error from this operation is calculated, and then diffused into neighboring pixels, to the right and down. It should be noted that unlike ordered dithering, this algorithm is a serial algorithm, operating on the image pixels one by one, starting at the upper left and working to the right and down. Once a pixel has been quantized it is no longer changed.

3. Experiments

To test the effects of image dithering on Holoimages, we performed both Bayer and Floyd-Steinberg dithering on Holoimages of a unit sphere and 3D scan of the statue of David. In all of our experiments we had a fringe frequency of 12, θ of 30 deg, and Holoimage size of 512×512.

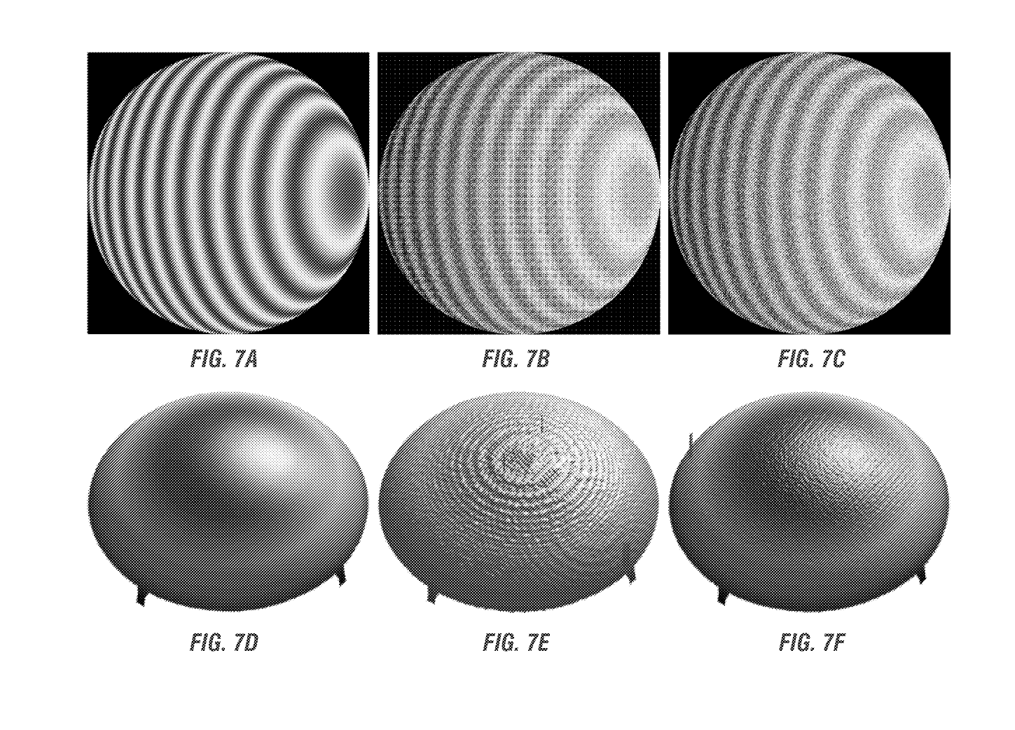

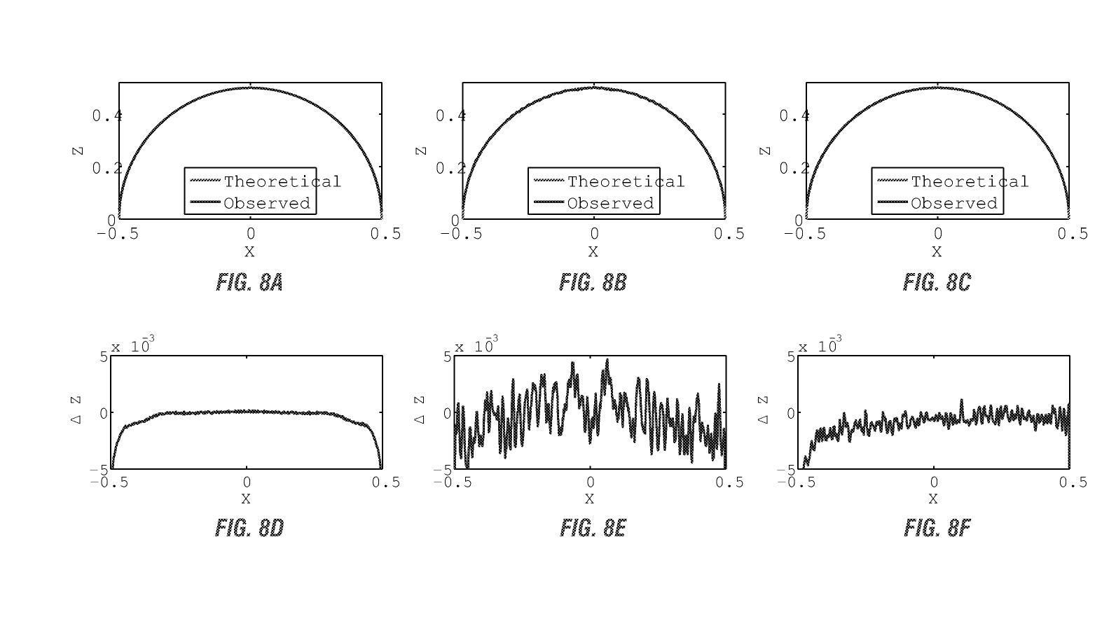

To begin we performed the dithering on the unit sphere and then stored the resulting images in the lossless PNG format. FIGS. 7A-8F show the results. FIG. 7A shows the Holoimage. Red, green, and blue (RGB) channels of the Holoimage are then dithered with the Bayer Dithering technique individually; and then stored into three most significant bits of the 8-bit grayscale image shown in FIG. 7B with R being stored as the most significant bit, and B being stored as the third significant bit. This grayscale image contain all the information required to recover the whole 3D geometry carried on by the 24-bit Holoimage shown in FIG. 7A. Similarly, the other dithering technique can also be employed to convert the 24-bit Holoimage into the three most significant bits of an 8-bit grayscale image. FIG. 7C shows the dithered image using the Floyd-Steinberg dithering technique.

Before the 3D geometry can be decoded from the Holoimage, 2D image processing needs to be reversed to attempt to put the Holoimage back into its original state. In terms of dithering, this can be done by applying a low-pass filter, such as a Gaussian filter, to the dithered image. In this research, we used a 7×7 Gaussian filter with a standard deviation of 7/3 pixels. It is also important to know that in the Holoimage pipeline, filtering can be applied after phase unwrapping. Previous work has shown that median filtering can remove spiking noise in the final reconstruction [21, 22]. This is done by median filtering, and then instead of using the median, detecting the correct number of phase jumps from the median and applying it to the phase at the current pixel.

FIG. 7C shows the reconstructed result from the Bayer-dithered pattern shown in FIG. 7B. In comparison with the 3D result recovered from the 24-bit Holoimage shown in FIG. 7D, the Bayer-dithered result has some random noise on top of the recovered 3D results. Yet, the sphere was well-recovered. FIG. 7F shows the recovered results using the Floyd-Steinberg dithering technique, it is significantly better than the result obtained from the Bayer-dithering technique.

To better compare these dithering techniques, FIGS. 8A-8F shows the cross sections of the recovered 3D results using different methods comparing with the ideal unit sphere. FIGS. 8A and 8D, respectively, show that the cross section of recovered 3D sphere overlapping with the ideal unit sphere, and the cross section of the difference between these two, when the 24-bit Holoimage is used. The results are smooth, and the error is small, which has been demonstrated previously [1]. The Bayer-dithered results (FIG. 8B and FIG. 8E) show that the overall geometry was recovered quite well, but error is larger: approximately root-mean-square (rms) error of 0.33%. It can be seen that this error is still quite small. Yet, the Floyd-Steinberg dithering technique can further improve the results, as shown in FIG. 8C and FIG. 8F. The error can be further reduced to be approximately rms 0.2%. It should be noted that only 3 bits were used to represent the 24 bit Holoimage, and the reconstructed geometry is still high quality.

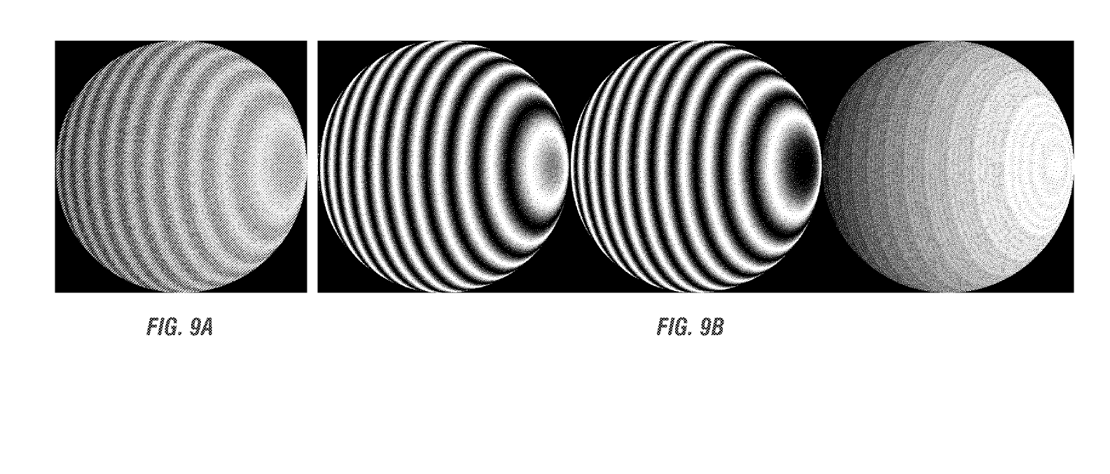

Compression results depend on how the resulting dithered information is stored. In this work JPEG and other lossy image compression was not used due to the fact that it makes use of a low pass filter before compression. This takes the 3 bit binary dithered information and transforms it back into 24 bit information, which is undesirable. Instead, PNG, a loseless image compression, was utilized and the three most significant bits of a grayscale image were utilized, shown by FIG. 9A. This resulted in a file size of 79 KB with the unit sphere. Further compression can be achieved by saving the image in a planar format, three times as wide with image channels one after another, and then saving the PNG as a logical 1 bit image. This resulted in a file size of 62 KB yielding a compression ratio of 3.9:1 when compared against a 24 bit Holoimage in the PNG format.

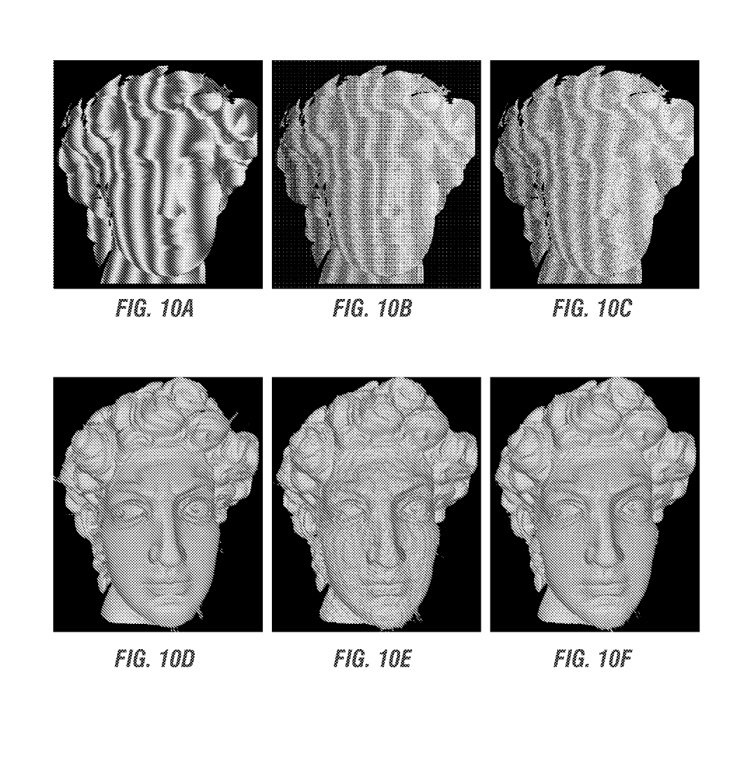

To further test dithering on Holoimages, the technique was performed on a scan of the statue of David shown in FIG. 10A-10F. FIG. 10A shows the 24-bit Holoimage, and FIG. 10D shows the recovered 3D geometry. The 24-bit Holoimage is then dithered into 3-bits and stored into three most significant bits of an 8-bit grayscale image. FIG. 10B and FIG. 10C, respectively, shows the Bayer-dithered result and the Floyd-Steinberg dithered result; and their recovered 3D shapes are shown in FIG. 10E and FIG. 10F. Again, it can be seen that Bayer dithering results in larger amounts of error seen as ripples and bumps on the surface; and Floyd-Steinberg dithering has some of these errors as well but it is not as prominent as is the case with Bayer dithering. Floyd-Steinberg dithering results a lower rms error or 0.34% when compared to Bayer dithering at 0.37%. The resulting file size is 39 KB, achieving a compression ratio of 8.2:1 when compared to the 24 bit Holoimage. Although it might be expected a simple unit sphere would have a higher compression, this is not the case as PNG compression depends on pre-compression and DEFLATE steps which can result in different

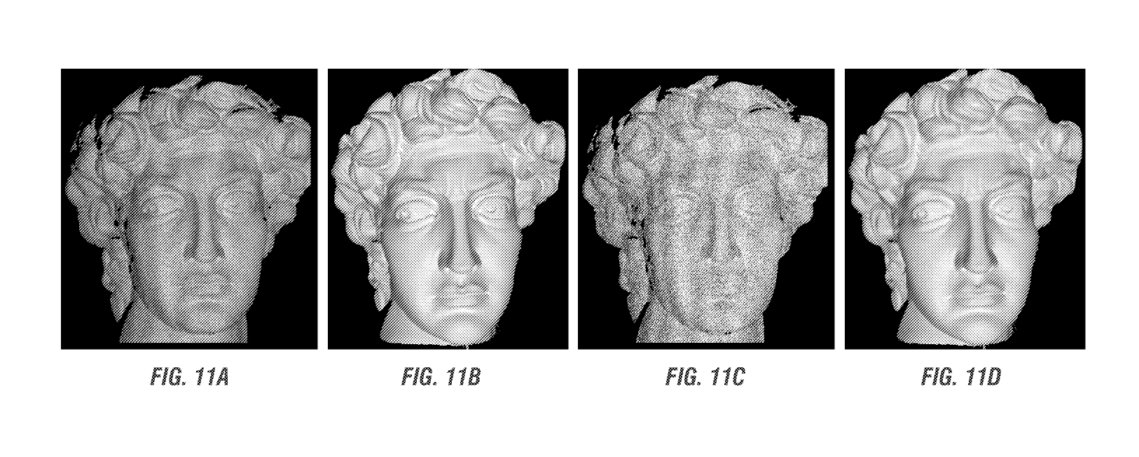

Since the proposed technique only requires 3 bits to represent the whole 3D geometry, there are 21 bits remaining to encode more information such as the grayscale texture that comes from the 3D scanner, which can be encoded into the same image. There are essentially two approaches to carry on texture with 3D geometry. The first method is to pack the 8bit grayscale image directly into the 24-bit image. FIG. 11A shows the resultant image, and its recovered 3D geometry with texture mapping is shown in FIG. 11B. The file size is approximately 189 KB, which is a substantial reduction comparing with original 24-bit Holoimage stored in PNG format 320 KB.

The 8-bit texture image can be dithered as well to further compress the data. FIG. 11C shows the packed image that stores the 3D geometry along with 1-bit dithered texture image into four most significant bits of an 8-bit grayscale image. From this image, the texture can be recovered by applying a very small Gaussian filter (7×7) as shown in FIG. 11D. It can be seen that the texture image is of good quality. With only 4 bits, the file size is approximately 64 KB. This example clearly demonstrates that the proposed technique can embed both the 3D geometry and the texture into a regular 2D image, making it a novel technique to store 3D range data in a substantially reduced size, with minor loss of quality. Furthermore, because it only utilizes 4 bits, this proposed 3D range data compression technique can be leveraged for applications where other critical information such as connectivity or bump maps need to be carried along.

4. Conclusion

A novel approach to represent 3D geometry has been presented, specifically applying image dithering to the Holoimage technique to reduce the bit depth from 24 bits to 3 bits. The technique was presented with two forms of image dithering, and sample data of a unit sphere and 3D scan of David have been demonstrated. A mean squared error of 0.2% was achieved on the unit sphere with a compression of 3.1:1 when compared with the 24 bit Holoimage technique, and a rms error of 0.34% was achieved on the scan of David with a compression of 8.2:1 when compared with the 24 bit Holoimage. With the remaining 21 bits, grayscale texture information was also encoded, effectively embedding 3D geometry and texture into a single 8-bit grayscale image.

Although specific embodiments of the present invention are described herein, the present invention is not to be limited to the specific embodiments. For example, the present invention contemplates variations in the hardware used to acquire 3D range data, variations in the computer graphics rendering pipeline used, variations in the number of bits that the three-dimensional data is reduced to (three bits or otherwise), and other variations, options, and alternatives.

### REFERENCES

1. N. Karpinsky and S. Zhang, “Holovideo: Real-time 3D video encoding and decoding on GPU,” Opt. Laser Eng. 50(2), 280-286 (2012).
2. S. Gumhold, Z. Kami, M. Isenburg, and H.-P. Seidel, “Predictive point-cloud compression,” ACM SIGGRAPH 2005 Sketches 137 (2005).
3. B. Merry, P. Marais, and J. Gain, “Compression of dense and regular point clouds,” Computer Graphics Forum 25(4), 709-716 (2006).
4. R. Schnabel and R. Klein, “Octree-based point-cloud compression,” Eurographics Symp. on Point-Based Graphics 111-120 (2006).
5. A. Jones, M. Lang, G. Fyffe, X. Yu, J. Busch, I. McDowall, M. Bolas, and P. Debevec, “Achieving eye contact in a one-to-many 3D video teleconferencing system,” SIGGRAPH '09 (2009).
6. X. Gu, S. Zhang, L. Zhang, P. Huang, R. Martin, and S.-T. Yau, “Holoimages,” ACM Solid and Physical Modeling, 129-138 (UK, 2006).
7. N. Karpinsky and S. Zhang, “Composite phase-shifting algorithm for three-dimensional shape compression,” Opt. Eng. 49(6), 063,604 (2010).
8. H. Schreiber and J. H. Bruning, Optical shop testing, chap. 14, 547-666, 3rd ed. (John Willey & Sons, New York, NY, 2007).
9. J. Novak, P. Novak, and A. Miks, “Multi-step phase shifting algorithms insensitive to linear phase shift errors,” Opt. Commun. 281, 5302-5309 (2008).
10. D. C. Ghiglia and M. D. Pritt, Two-dimensional phase unwrapping: Theory, algorithms, and software (John Wiley and Sons, Inc., New York, N.Y., 1998).
11. S. Zhang and P. S. Huang, “Novel method for structured light system calibration,” Opt. Eng. 45(8), 083,601 (2006).
12. G. Geng, “Structured-light 3D surface imaging: a tutorial,” Advances in Opt. and Photonics 3(2), 128-160 (2011).
13. S. Zhang, “Recent progresses on real-time 3-D shape measurement using digital fringe projection techniques,” Opt. Laser Eng. 48(2), 149-158 (2010).
14. X. Gu, S. J. Gortler, and H. Hoppe, “Geometry images,” ACM Trans. on Graphics 21(3), 355-361 (2002).
15. R. Krishnamurthy, B. Chai, and H. Tao, “Compression and transmission of depth maps for image-based rendering,” Image Proc. 1(c), 828-831 (2002).
16. Z. Hou, X. Su, and Q. Zhang, “Virtual structured-light coding for three-dimensional shape data compression,” Opt. Laser Eng. 50(6), 844-849 (2012).
17. T. L. Schuchman, “Dither signals and their effect on quantization noise,” IEEE Trans. Communication Technology 12(4), 162-165 (1964).
18. B. Bayer, “An optimum method for two-level rendition of continuous-tone pictures,” IEEE Int'l Conf. Communications 1, 11-15 (1973).
19. T. D. Kite, B. L. Evans, and A. C. Bovik, “Modeling and quality assessment of Halftoning by error diffusion,” IEEE Int'l Conf. on Image Proc. 9(5), 909-922 (2000).
20. F. R. W., “An adaptive algorithm for spatial gray -scale,” Proc. Soc. Inf. Disp. 17, 75-77 (1976).
21. N. Karpinsky and S. Zhang, “Generalizing Holovideo to H.264,” SPIE Electronic Imaging (San Francisco, California, 2012).
22. M. McGuire, “A fast, small-radius GPU median filter,” ShaderX6 (2008).

What is claims is:

1. A method comprising:
obtaining three-dimensional range data;
using a computer graphics rendering pipeline to encode the three-dimensional range data into two-dimensional images;
retrieving depth information for each sampled pixel in the two-dimensional images;
encoding the depth information into red, green and blue color channels of the two-dimensional images using a computing device.

2. The method of claim 1 further comprising compressing the two-dimensional images using two-dimensional image compression technique.

3. The method of claim 2 wherein the two-dimensional image compression technique comprises dithering.

4. The method of claim 3 further comprising storing two-dimensional texture images and the three-dimensional range data in two-dimensional gray scale images.

5. The method of claim 1 wherein the step of obtaining the three-dimensional range data is performed using a three-dimensional range scanning device.

6. The method of claim 1 further comprising storing the two-dimensional images on a computer readable storage medium.

7. The method of claim 1 further comprising setting up the viewing angle for the three-dimensional range data.

8. The method of claim 7 wherein the viewing angle for the three-dimensional range data is a viewing angle of a camera used in obtaining the three-dimensional range data.

9. The method of claim 1 wherein the computer graphics rendering pipeline provides for geometry processing, projection, and rasterization.

10. The method of claim 1 further comprising recovering three-dimensional range data from the two-dimensional images.

11. The method of claim 1 further comprising displaying a representation of the three-dimensional range data on a display.

12. A representation of three-dimensional range data stored on a computer readable storage medium comprising a plurality of two-dimensional images stored in a two-dimensional image file format wherein the two-dimensional images encode the three-dimensional range data with depth information for the three-dimensional range data encoded into red, green, and blue color channels of the two-dimensional images.

13. The representation of three-dimensional range data of claim 12 wherein the two-dimensional images further include texture information.

14. A computing device executing instructions for reading the three-dimensional range data of claim 12.

15. A method comprising:
providing a plurality of two-dimensional images stored in a two-dimensional image file format on a computer readable storage medium wherein the two-dimensional images encode the three-dimensional range data with depth information for the three-dimensional range data encoded into red, green, and blue color channels of the two-dimensional images; and
recovering the three-dimensional range data from the two-dimensional images using a computing device.

16. The method of claim 17 further comprising displaying a representation of the three-dimensional range data on a display.

17. A representation of three-dimensional range data stored on a computer readable storage medium comprising a two-dimensional image format file and associated with an image and representing the three-dimensional range data with fewer than or equal to 24 bits using dithering techniques and two-dimensional texture images.

18. A computing device executing instructions for reading the three-dimensional range data of claim 17 from the computer readable storage medium.
